(19) United States
(12) Patent Application Publication
(10) Pub. No.: US 2025/0187497 A1
(43) Pub. Date: Jun. 12, 2025

(54) VEHICLE SEAT SECURING SYSTEM AND METHOD

(71) Applicant: Ford Global Technologies, LLC, Dearborn, MI (US)

(72) Inventors: Deanna Marie Winton Hoffman, Ann Arbor, MI (US); Daniel Patrick Maguire, Ann Arbor, MI (US); Daniel Benjamin Kok, Ann Arbor, MI (US)

(21) Appl. No.: 18/637,739

(22) Filed: Apr. 17, 2024

Related U.S. Application Data
(60) Provisional application No. 63/607,888, filed on Dec. 8, 2023.

(51) Int. Cl. B60N 2/005; B60K 1/04

(52) U.S. Cl. CPC B60N 2/005; B60K 1/04

(57) ABSTRACT

A vehicle seat securing system includes a traction battery pack, and a seat mounting cross-member assembly that extends into the traction battery pack. A vehicle seat securing method includes securing the vehicle seat to the seat mounting cross-member assembly using at least one threaded fastener.

### CROSS-REFERENCE TO RELATED APPLICATIONS

This disclosure claims priority to U.S. Provisional Application No. 63/607,888, which was filed on Dec. 8, 2023, and is incorporated herein by reference in its entirety.

### TECHNICAL FIELD

This disclosure relates generally to positioning a seat mounting cross-member assembly within a vehicle, and more particularly, to a seat mounting cross-member assembly that is at least partially received within a traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

In some aspects, the techniques described herein relate to a vehicle seat securing system, including: a traction battery pack; and a seat mounting cross-member assembly that extends into the traction battery pack.

In some aspects, the techniques described herein relate to a vehicle seat securing system, wherein a portion of the seat mounting cross-member assembly vertically overlaps with a portion of the traction battery pack.

In some aspects, the techniques described herein relate to a vehicle seat securing system, wherein the traction battery pack vertically overlaps with a portion of the seat mounting cross-member assembly.

In some aspects, the techniques described herein relate to a vehicle seat securing system, wherein a portion of the seat mounting cross-member assembly vertically overlaps with at least one cell stack of the traction battery pack.

In some aspects, the techniques described herein relate to a vehicle seat securing system, wherein a portion of the seat mounting cross-member assembly is disposed between a first cell stack and a second cell stack of the traction battery pack.

In some aspects, the techniques described herein relate to a vehicle seat securing system, further including an enclosure cover of the traction battery pack, the enclosure cover having an aperture that receives a portion of the seat mounting cross-member assembly.

In some aspects, the techniques described herein relate to a vehicle seat securing system, further including a seat directly connected to the seat mounting cross-member assembly.

In some aspects, the techniques described herein relate to a vehicle seat securing system, wherein the traction battery pack is vertically beneath a passenger compartment of the vehicle.

In some aspects, the techniques described herein relate to a vehicle seat securing system, wherein the seat mounting cross-member assembly is attached directly to an enclosure tray of the traction battery pack.

In some aspects, the techniques described herein relate to a vehicle seat securing system, wherein a portion of the seat mounting cross-member assembly is disposed horizontally between a passenger side rocker and a driver side rocker of the vehicle.

In some aspects, the techniques described herein relate to a vehicle seat securing system, wherein the seat mounting cross-member assembly extends longitudinally in a cross-vehicle direction.

In some aspects, the techniques described herein relate to a vehicle seat securing system, wherein the seat mounting cross-member assembly extends vertically into an interior of an enclosure of the traction battery pack.

In some aspects, the techniques described herein relate to a vehicle seat securing method, including: positioning at least a portion of a seat mounting cross-member assembly within a traction battery pack; and securing a vehicle seat to the seat mounting cross-member assembly.

In some aspects, the techniques described herein relate to a vehicle seat securing method, wherein the seat mounting cross-member assembly extends longitudinally in a cross-vehicle direction.

In some aspects, the techniques described herein relate to a vehicle seat securing method, further including securing the seat mounting cross-member assembly to an enclosure tray of the battery pack.

In some aspects, the techniques described herein relate to a vehicle seat securing method, further including securing the vehicle seat to the seat mounting cross-member assembly using at least one threaded fastener.

In some aspects, the techniques described herein relate to a vehicle seat securing method, wherein a portion of the seat mounting cross-member assembly vertically overlaps with a portion of the traction battery pack.

In some aspects, the techniques described herein relate to a vehicle seat securing method, wherein a portion of the seat mounting cross-member assembly vertically overlaps with at least one cell stack of the traction battery pack.

In some aspects, the techniques described herein relate to a vehicle seat securing method, wherein the portion of the seat mounting cross-member assembly is received within an opening of an enclosure tray of the battery pack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates a perspective and partially expanded view of selected portions of the battery pack of FIG. 1, along with seats from the vehicle and a seat mounting cross-member assembly.

FIG. 3 illustrates a section view taken at line 3-3 in FIG. 2 when the seat mounting cross-member assembly is in the installed position with the traction battery pack.

FIG. 4 illustrates a section view taken generally at line 4-4 in FIG. 3.

FIG. 5 illustrates a top view of a bracket of the seat mounting cross-member assembly of FIGS. 2-4.

FIG. 6 illustrates a close-up view of an area of FIG. 4 showing the traction battery pack overlapping with the seat mounting cross-member assembly according to an exemplary embodiment of the present disclosure.

FIG. 7 illustrates the traction battery pack vertically overlapping with a portion of a seat mounting cross-member assembly according to yet another exemplary embodiment of the present disclosure.

FIG. 8 illustrates a section view of the traction battery pack vertically overlapping with a portion of a seat mounting cross-member assembly according to yet another exemplary embodiment of the present disclosure.

FIG. 9 illustrates a section view of the traction battery pack vertically overlapping with a portion of a seat mounting cross-member assembly according to yet another exemplary embodiment of the present disclosure

FIG. 9A illustrates a closeup view of an area in FIG. 9.

### DETAILED DESCRIPTION

This disclosure details exemplary vehicle seat securing systems and methods that rely on a seat mounting cross-member assembly that is at least partially received within a traction battery pack of a vehicle. This positioning of the seat mounting cross-member assembly can reduce a required height when compared to a seat mounting cross-member assembly that is not received within a traction battery pack. These and other features are discussed in greater detail in the following paragraphs of this detailed description.

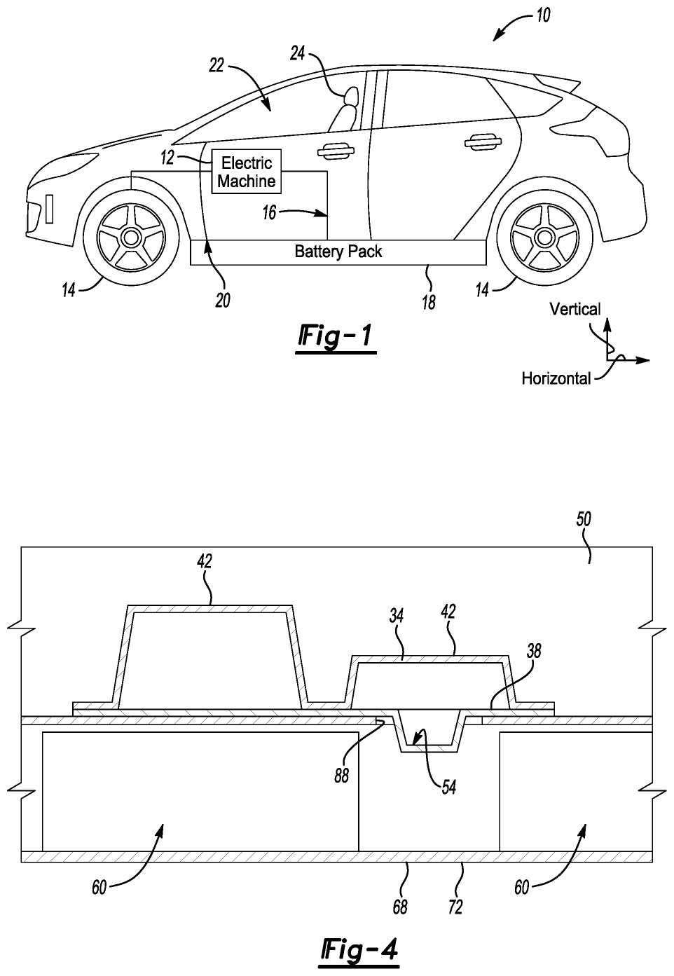

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10 beneath a passenger compartment 22 of the vehicle 10. Within the passenger compartment 22, the vehicle 10 can include one or more seats 24.

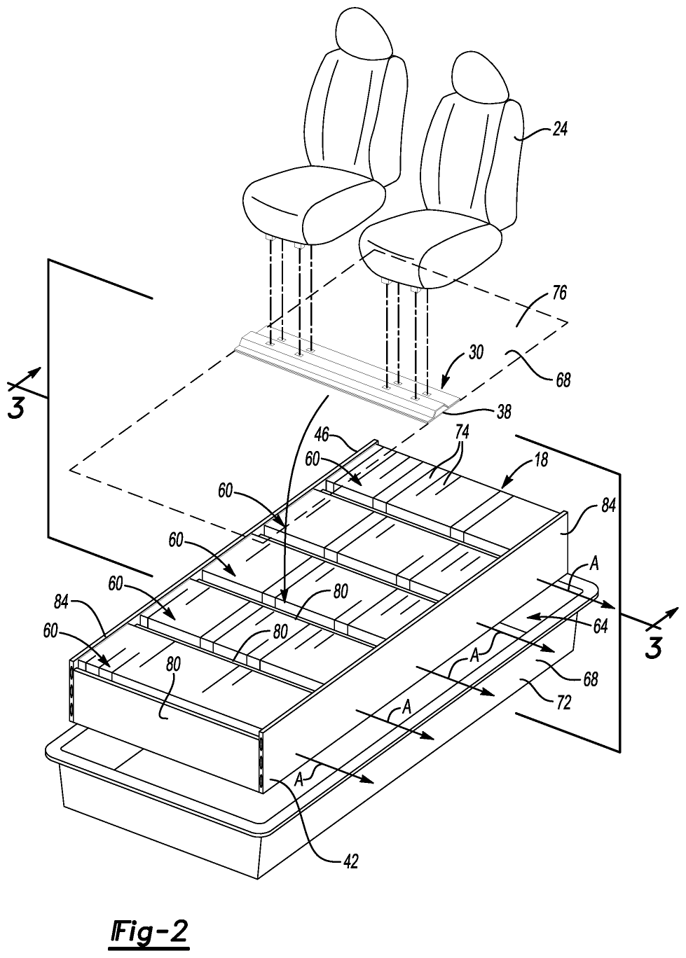

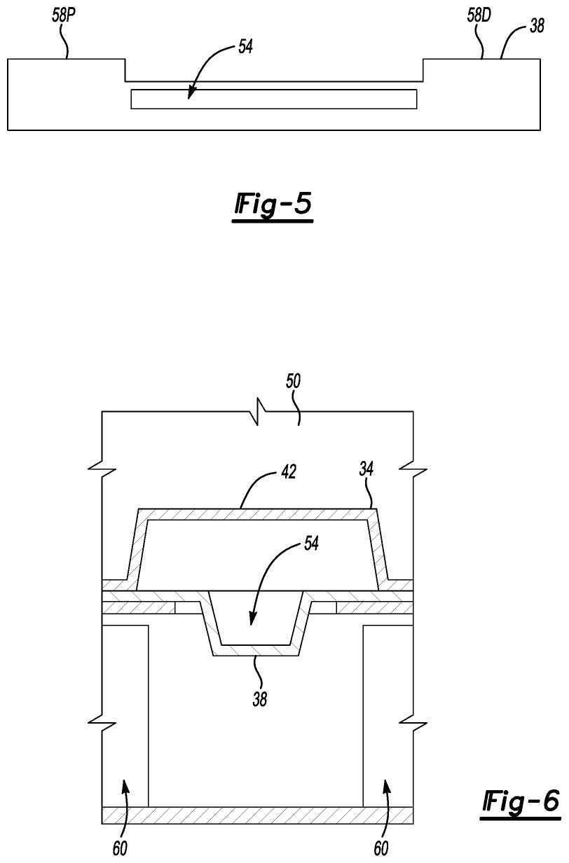

With reference now to FIGS. 2-6, the seats 24 of the vehicle 10 can be secured to a seat mounting cross-member assembly 30. In the exemplary embodiment, the seats 24 can be secured to the seat mounting cross-member assembly 30 to provide a front row of seating within the passenger compartment 22. The vehicle 10 can include one or more additional rear rows of seats that secure to other respective seat mounting cross-member assemblies.

The seat mounting cross-member assembly 30 in the exemplary embodiment includes a first bracket 34 joined to a second bracket 38. In this example, the first bracket 34 is stamped to establish two top hat sections 42 that, when the seat mounting cross-member assembly 30 is installed, open vertically downward. The example first bracket 34 is a single piece of material having both the two top hat sections 42. In other examples, the first bracket 34 could be formed of multiple pieces of material-one piece could establish one of the top hat sections and another piece could establish the other top hat section. Further, while stamping is used to establish the top hat sections of the example first bracket 34, other examples could rely on roll forming or another process, such as roll forming, to provide the top hat sections 42. The first bracket 34 can be steel or some other metal.

Vertical and horizontal, for purposes of this disclosure, are with reference to ground in a general orientation of the pack 18 when installed within the vehicle of FIG. 1.

The first bracket 34 extends horizontally in a cross-vehicle direction between a driver side rocker 46D and a passenger side rocker 46P. Respective panels 50 can be positioned between the first bracket 34 of the seat mounting cross-member assembly 30 and the rockers 46D, 46P. The rockers 46D, 46P are body structures. The rockers 46D, 46P can be considered rails in some examples, such as when the vehicle 10 is a body-on-frame vehicle rather than a unibody vehicle.

The second bracket 38 of the seat mounting cross-member assembly 30 includes a pocket 54 disposed between a driver's side panel 58D and a passenger side panel 58P. The pocket 54 can be stamped into the second bracket 38. In this example, the driver's side panel 58D, the passenger side panel 58P, and the area providing the pocket 54 are all formed from a single sheet of material. Alternatively, the pocket 54 could be stamped into a piece of material. The driver's side panel 58D and the passenger side panel 58P are then joined to the panel providing the pocket 54 via welds, for example.

The pocket 54 opens upward when the seat mounting cross-member assembly 30 is installed. The pocket 54, along with the top hat sections 42 of the first bracket 34, enhance the structural integrity of the seat mounting cross-member assembly 30 and facilitate meeting load transfer goals.

The traction battery pack 18 includes a plurality of cell stacks 60 held within an interior area 64 of an enclosure assembly 68. In the exemplary embodiment, the enclosure assembly 68 includes an enclosure tray 72 and an enclosure cover 76. The enclosure tray 72 can be secured to the enclosure cover 76 to enclose the cell stacks 60 within the interior area 64.

Each of the cell stacks 60 includes a plurality of individual battery cells 74 stacked side-by-side relative to each other along a respective cell stack axis A. The battery cells 74 can store and supply electrical power for powering various components of the electrified vehicle 10. Although a specific number of the cell stacks 60 and battery cells 74 are illustrated in the various figures of this disclosure, the traction battery pack 18 could have any number of the cells stacks 60 with each cell stack 60 having any number of individual battery cells 74.

In the exemplary embodiment, the battery cells 74 are lithium-ion pouch cells. However, battery cells having other geometries (cylindrical, prismatic, etc.) and/or chemistries (nickel-metal hydride, lead-acid, etc.) could alternatively be utilized within the scope of this disclosure.

In the exemplary embodiment, the battery cells 74 of each cell stack 60 are arranged between a pair of cross-member assemblies 80. Among other functions, the cross-member assemblies 80 can be configured to hold the battery cells 74 and to at least partially delineate the cell stacks 60 from each other within the interior area 64. Each battery pack cross-member assembly 80 can be configured to transfer loads applied to a side of the vehicle 10. Each battery pack cross-member assembly 80 can be further configured to accommodate tension loads resulting from expansion and contraction of the battery cells 74. The battery pack cross-member assembly 80 are configured to increase the structural integrity of the traction battery pack 18.

Opposing axial ends of the cross-member assemblies 80 directly interface with end plates 84 that extend longitudinally along a length of the cell stack 60 within the battery pack 18. The end plates 84 each span all of the cell stacks 60 within the battery pack 18. The end plates 84 can be extruded. When in an installed position the end plates 84 can be positioned between each cell stack 60 and a respective sidewall of the enclosure tray 72.

In the exemplary embodiment a portion of the seat mounting cross-member assembly 30—here at least the pocket 54 of the second bracket 38—extends vertically downward into the battery pack 18. That is, the seat mounting cross-member assembly 30 vertically overlaps with the portion of the traction battery pack 18. The enclosure cover 76 includes an aperture 88 that receives the pocket 54 to permit the seat mounting cross-member assembly 30 to overlap with the battery pack 18.

In the exemplary embodiment, the second bracket 38 vertically overlaps with the battery pack 18 and, in particular, at least one of the cell stacks 60. As shown in FIG. 4, the pocket 54 extends vertically downward between two of the cell stacks 60.

The seats 24 can be directly joined to the top hat sections 42 of the first bracket 34 in the seat mounting cross-member assembly 30. Mechanical fasteners, such as threaded fasteners, can be used to secure the seats 24 to the first bracket 34.

The overlapping of the seat mounting cross-member assembly 30 with the traction battery pack 18 can reduce an overall packaging requirement in a vertical direction for the seat mounting cross-member assembly 30 along with the traction battery pack 18.

If a load is applied to a side of the vehicle 10, the section height being reduced in area 90 can establish flexure points at these areas. In some examples, reinforcement flanges 94 can be added to enhance load transfer between the rockers 46D, 46P and the first bracket 134 of the seat mounting cross-member assembly 30. Flanges 98 could also be added to facilitate flexural stiffness and durability by effectively increasing a section height at flexure nodes.

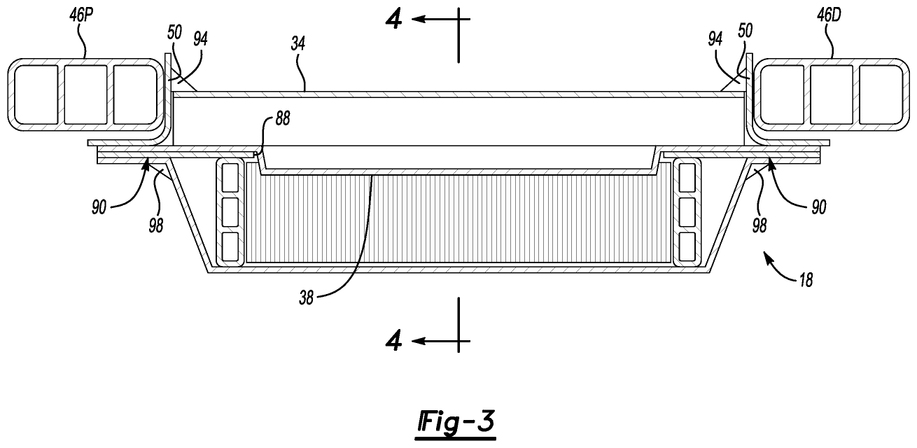

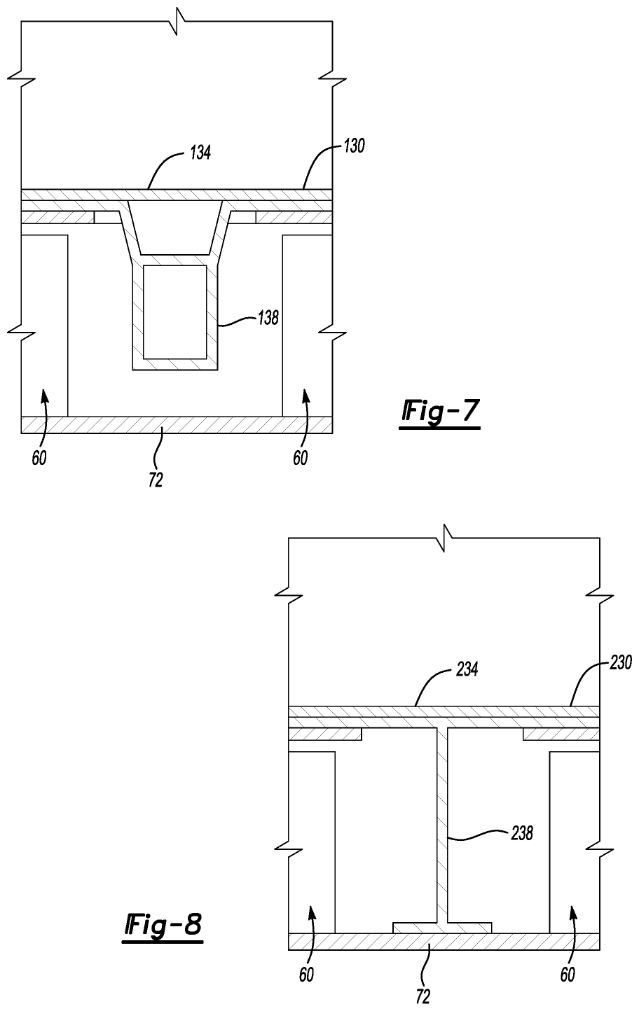

With reference now to FIG. 7, another exemplary embodiment of a seat mounting cross-member assembly 130 includes a first bracket 134 that is substantially planar, and a second bracket 138 having more cross-sectional area than the pocket 54 of the embodiment of FIGS. 3-6. Increasing a cross-sectional area of the second bracket 138 can allow the seat mounting cross-member assembly 130 to meet load transfer goals without significant structure formed in the first bracket 134.

The seat mounting cross-member assembly 130 overlaps more with the traction battery pack 18 than the seat mounting cross-member assembly 30. The embodiment of FIG. 7 thus reduces a required packaging height more than the seat mounting cross-member assembly 30 further by overlapping more of the seat mounting cross-member assembly 130 with the traction battery pack 18.

With reference now to FIG. 8, in a further exemplary embodiment a seat mounting cross-member assembly 230 includes a first bracket 234 that is substantially planar and a second bracket 238 that has an I-beam like cross-sectional provide configuration. The second bracket 238 can extend vertically downward and attach directly to the enclosure tray 72 or, in some examples, a cold plate assembly. In still other examples, the second bracket 238 may extend to, or near to, the enclosure tray 72, but not connect to the enclosure tray 72.

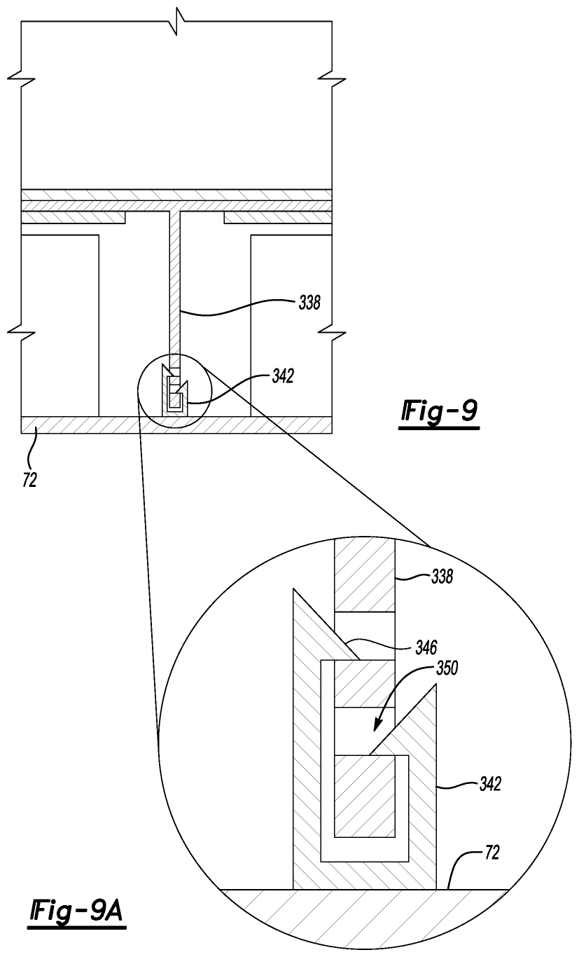

With reference now to FIGS. 9 and 9A, in a variation, an anchoring structure 342 is secured to the enclosure tray 72. The anchoring structure 342 engages the second bracket 338 of the seat mounting cross-member assembly 330 via prongs 346 received within apertures 350 of the second bracket 338. Engagement of the second bracket 338 with the anchoring structure 342 can occur by moving the second bracket 238 vertically downward until the prongs 246 are received within the respective apertures 250.

Features of the disclosed examples include a seat mounting cross-member assembly and a traction battery pack having a reduced vertical height requirement due to an overlapping of at least a portion of the seat mounting cross-member assembly with at least a portion of the traction battery pack. Reducing a height of a vehicle can enhance aerodynamics and overall vehicle performance.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle seat securing system, comprising:
a traction battery pack; and
a seat mounting cross-member assembly that extends into the traction battery pack.

2. The vehicle seat securing system of claim 1, wherein a portion of the seat mounting cross-member assembly vertically overlaps with a portion of the traction battery pack.

3. The vehicle seat securing system of claim 1, wherein the traction battery pack vertically overlaps with a portion of the seat mounting cross-member assembly.

4. The vehicle seat securing system of claim 1, wherein a portion of the seat mounting cross-member assembly vertically overlaps with at least one cell stack of the traction battery pack.

5. The vehicle seat securing system of claim 1, wherein a portion of the seat mounting cross-member assembly is disposed between a first cell stack and a second cell stack of the traction battery pack.

6. The vehicle seat securing system of claim 1, further comprising an enclosure cover of the traction battery pack, the enclosure cover having an aperture that receives a portion of the seat mounting cross-member assembly.

7. The vehicle seat securing system of claim 1, further comprising a seat directly connected to the seat mounting cross-member assembly.

8. The vehicle seat securing system of claim 1, wherein the traction battery pack is vertically beneath a passenger compartment of the vehicle.

9. The vehicle seat securing system of claim 1, wherein the seat mounting cross-member assembly is attached directly to an enclosure tray of the traction battery pack.

10. The vehicle seat securing system of claim 1, wherein a portion of the seat mounting cross-member assembly is disposed horizontally between a passenger side rocker and a driver side rocker of the vehicle.

11. The vehicle seat securing system of claim 1, wherein the seat mounting cross-member assembly extends longitudinally in a cross-vehicle direction.

12. The vehicle seat securing system of claim 1, wherein the seat mounting cross-member assembly extends vertically into an interior of an enclosure of the traction battery pack.

13. A vehicle seat securing method, comprising:
positioning at least a portion of a seat mounting cross-member assembly within a traction battery pack; and
securing a vehicle seat to the seat mounting cross-member assembly.

14. The vehicle seat securing method of claim 13, wherein the seat mounting cross-member assembly extends longitudinally in a cross-vehicle direction.

15. The vehicle seat securing method of claim 13, further comprising securing the seat mounting cross-member assembly to an enclosure tray of the battery pack.

16. The vehicle seat securing method of claim 13, further comprising securing the vehicle seat to the seat mounting cross-member assembly using at least one threaded fastener.

17. The vehicle seat securing method of claim 13, wherein a portion of the seat mounting cross-member assembly vertically overlaps with a portion of the traction battery pack.

18. The vehicle seat securing method of claim 13, wherein a portion of the seat mounting cross-member assembly vertically overlaps with at least one cell stack of the traction battery pack.

19. The vehicle seat securing method of claim 13, wherein the portion of the seat mounting cross-member assembly is received within an opening of an enclosure tray of the battery pack.
